(19) United States
(12) Patent Application Publication
(10) Pub. No.: US 2016/0351953 A1
(43) Pub. Date: Dec. 1, 2016

(54) SOLID ELECTROLYTE SEPARATOR FOR LITHIUM CONVERSION CELL

(71) Applicant: Robert Bosch GmbH, Stuttgart (DE)

(72) Inventors: Thomas Wöhrle, Munchen (DE); Calin Iulius Wurm, Meitingen (DE); Vikram Anil Godbole, Leinfelden (DE)

(21) Appl. No.: 15/168,420

(22) Filed: May 31, 2016

(30) Foreign Application Priority Data
May 29, 2015 (DE) 10 2015 209 981.4

(51) Int. Cl. H01M 10/0562; H01M 2/16; H01M 10/0525

(52) U.S. Cl. CPC H01M 10/0562; H01M 10/0525; H01M 2/1686; H01M 2/1646

(57) ABSTRACT

A solid electrolyte separator (10) for a lithium cell (100), especially for a lithium conversion cell, for example for a lithium-oxygen cell or for a lithium-sulfur cell. In order to simplify the assembly of the cell or battery and to extend its lifetime, the solid electrolyte separator (10) comprises a solid electrolyte base layer (11), which (11) is coated firstly with a first solid electrolyte coating (12) and secondly with a second solid electrolyte coating (13).

### BACKGROUND OF THE INVENTION

The present invention relates to a solid electrolyte separator for a lithium cell, to a lithium cell and to a lithium battery.

Lithium conversion cells and batteries are predestined for a wide range of applications and, among other features, particularly on account of a conversion reaction, for example of oxygen or sulfur, have a particularly high energy density or specific energy.

Lithium-oxygen cells comprise a cathode, which is also referred to as positive electrode or oxygen cathode or oxygen electrode, for oxidation and reduction of oxygen, and an anode, which is also referred to as negative electrode, based on lithium, particularly metallic lithium.

In the discharge of a lithium-oxygen cell, the following reactions take place at the anode and the cathode:

anode: 2Li→2Li⁺+2e⁻

cathode: 2Li⁺+2e⁻+O₂→Li₂O₂

In the discharge of a lithium-oxygen cell, lithium is oxidized to lithium ions at the anode, the lithium ions being released in the direction of the cathode and electrons to an external circuit, with reduction of gaseous oxygen and formation of lithium peroxide (Li₂O₂) at the cathode.

In the charging of a lithium-oxygen cell, the following reactions take place at the anode and the cathode:

anode: 2Li⁺+2e⁻→2Li

cathode: Li₂O₂→2Li⁺+2e⁻+O₂

In the charging of a lithium-oxygen cell, oxidation of the lithium peroxide to gaseous oxygen and also lithium ions and electrons at the cathode is brought about by the external circuit. At the same time, lithium ions and electrons are combined to metallic lithium at the anode.

In the publication U.S. Pat. No. 5,510,209 A, Abraham et al. describe a lithium-air cell having a metallic lithium anode and an oxygen cathode.

Jake Christensen et al., in Journal of The Electrochemical Society (159 (2) R1-R30 (2012)), published a review of lithium-air technology.

Lithium-air cells are known from the company Polyplus, United States of America, California.

Bruce et al. (A Reversible and Higher-Rate Li—O2-Battery; Zhangquan Peng, Stefan A. Freunberger, Yuhui Chen, Peter G. Bruce; Science Express Reports; Jul. 25, 2012; Science DOI: 10.1126/science.1223985) describe nanoporous gold cathodes.

The publication U.S. Pat. No. 7,282,296 B2 relates to ion-conductive composites for protection of active metal anodes.

### SUMMARY OF THE INVENTION

The present invention provides a solid electrolyte separator for a lithium cell. More particularly, the solid electrolyte separator may be designed for a lithium conversion cell, for example for a lithium-oxygen cell or for a lithium-sulfur cell.

A lithium conversion cell may especially be understood to mean an electrochemical cell, for example a battery cell, for example a secondary or primary battery cell, wherein lithium and a conversion material, for example oxygen or sulfur, are involved in the electrochemical reaction thereof, with chemical conversion, especially reduction or oxidation, of the conversion material in the course of the electrochemical reaction. For example, a lithium conversion cell may be a lithium-oxygen cell, for example a lithium-air cell, or a lithium-sulfur cell.

More particularly, the solid electrolyte separator may comprise a solid electrolyte base layer. The solid electrolyte base layer may especially be coated with at least one solid electrolyte coating.

This solid electrolyte base layer may especially be coated firstly with a first solid electrolyte coating and secondly with a second solid electrolyte coating. The solid electrolyte separator here may especially have a sandwich-like structure or take the form of a sandwich-like layer system in which the solid electrolyte base layer is disposed between the first and second solid electrolyte coatings.

By virtue of the solid electrolyte base layer being coated with the at least one solid electrolyte coating, especially with the first and second solid electrolyte coatings, it is advantageously possible to protect the solid electrolyte base layer. For example, the solid electrolyte base layer can be protected from contact with air or elemental oxygen and/or moisture or water or with elemental sulfur and/or sulfur compounds. Alternatively or additionally, the solid electrolyte base layer may be protected from contact with metallic lithium.

This advantageously enables formation of the solid electrolyte base layer from a material, for example a solid-state lithium ion conductor, which may have a high or very high lithium ion conductivity, especially at room temperature, for example of not less than 10⁻³ S/cm, for example from 10⁻³ S/cm to 10⁻¹ S/cm, but may be unstable to air and/or elemental oxygen and/or moisture and/or water and/or elemental sulfur and/or sulfur compounds, for example polysulfides, disulfides and/or monosulfides, and/or metallic lithium.

In addition, by virtue of the solid electrolyte base layer being coated with the at least one solid electrolyte coating, especially with the first and second solid electrolyte coatings, it is also possible to protect the cathode material, for example a catalyst for catalysis of a reduction of elemental oxygen to oxygen ions and/or for catalysis of an oxidation of oxygen ions to elemental oxygen and/or elemental sulfur and/or sulfur compounds, and/or the anode material, for example metallic lithium, from an unwanted reaction with the material of the solid electrolyte base layer. The at least one solid electrolyte coating, especially the first and second solid electrolyte coatings, of the solid electrolyte separator may therefore advantageously also serve as protective layer for the cathode or anode of the cell to be equipped therewith.

The at least one solid electrolyte coating, especially the first and/or second solid electrolyte coating, may, for example, be formed from a material, for example a solid-state lithium ion conductor, which is stable to or unreactive with air and/or elemental oxygen and/or moisture and/or water and/or elemental sulfur and/or sulfur compounds, such as polysulfides, disulfides and/or monosulfides, and/or metallic lithium.

For example, the first solid electrolyte coating may be formed from a material, for example a solid-state lithium ion conductor, which is stable to or unreactive with air and/or elemental oxygen and/or moisture and/or water and/or elemental sulfur and/or sulfur compounds, especially polysulfides, disulfides and/or monosulfides. By virtue of the stability of the solid electrolyte coating, especially the first solid electrolyte coating, to air and/or elemental oxygen and/or moisture and/or water and/or elemental sulfur and/or sulfur compounds, especially polysulfides, disulfides and/or monosulfides, the separator can advantageously be used especially for protection of the cathode, for example of a lithium-oxygen cell and/or battery and/or lithium-sulfur cell and/or battery. The second solid electrolyte coating may, for example, be formed from a material, for example a solid-state lithium ion conductor, which is stable to or unreactive with metallic lithium. By virtue of the stability of the second solid electrolyte coating to metallic lithium, the separator can advantageously be used especially for protection of the anode, for example of a lithium-oxygen cell and/or battery and/or lithium-sulfur cell and/or battery.

More particularly, the at least one solid electrolyte coating, for example the first and/or second solid electrolyte coating, may be formed from a material, for example a solid-state lithium ion conductor, which is stable to or unreactive with air, moisture and metallic lithium.

By virtue of the solid electrolyte base layer being arranged between the first and second solid electrolyte coatings, it is advantageously possible to protect the solid electrolyte base layer from a reaction with air and/or moisture and/or metallic lithium both during the operation of the cell or battery and additionally at the sides during the assembly of the cell or battery.

By virtue of the protection during the operation of the cell or battery, it is advantageously possible to achieve a prolonged lifetime of the cell or battery.

By virtue of the protection during the assembly, it is advantageously possible to simplify the assembly of the cell or battery and, for example, to shorten the processing time. Since the peripheral surfaces of the solid electrolyte base layer are small compared to the main areas of the solid electrolyte base layer protected by the solid electrolyte coatings, it is only possible for reactions to take place to a negligibly small degree at these surfaces—especially if the assembly of the cell or battery proceeds quickly enough—and for this reason it is optionally possible to process these surfaces in uncoated and hence unprotected form. In this way, it is again advantageously possible to simplify the production of the solid electrolyte separator.

In the context of one embodiment, the solid electrolyte base layer has a higher lithium ion conductivity than the at least one solid electrolyte coating, especially than the first solid electrolyte coating and/or than the second solid electrolyte coating. More particularly, the solid electrolyte base layer may have a higher lithium ion conductivity than the first solid electrolyte coating and than the second solid electrolyte coating. For example, the first solid electrolyte coating and/or the second solid electrolyte coating may only have a small lithium ion conductivity, especially at room temperature, for example of less than 10⁻³ S/cm, for example within a range from about 10⁻⁷ S/cm to 10⁻⁴ S/cm. By virtue of the solid electrolyte base layer, which may be unstable, for example, and has a high lithium ion conductivity being arranged, especially in a sandwich-like manner, between the two solid electrolyte coatings, which may be stable, for example, and have a lower lithium ion conductivity, it is advantageously possible to achieve the advantageous properties both of one system and of the other.

In the context of a further embodiment, the at least one solid electrolyte coating, especially the first solid electrolyte coating and/or the second solid electrolyte coating, has a lower layer thickness than the solid electrolyte base layer. More particularly, the first solid electrolyte coating and the second solid electrolyte coating may have a lower layer thickness than the solid electrolyte base layer. By virtue of the outer solid electrolyte coatings having a thin configuration, it is advantageously possible to reduce internal resistances caused by a lower lithium ion conductivity of the solid electrolyte coatings, and it is possible, in combination with a high lithium ion conductivity of the solid electrolyte base layer, to achieve a high lithium ion conductivity of the solid electrolyte separator overall. In this way, it is advantageously possible to provide a solid electrolyte separator which has a high total lithium ion conductivity or a low total internal resistance and is stable, especially to air, moisture and metallic lithium. In this way, it is advantageously possible to improve the performance or function of the cell or battery.

In the context of a further embodiment, the solid electrolyte base layer has a layer thickness (d₁₁) within a range from ≧25 μm to ≦500 μm, for example from ≧50 μm to ≦300 μm.

In the context of a further embodiment, the at least one solid electrolyte coating, especially the first solid electrolyte coating and/or the second solid electrolyte coating, for example the first solid electrolyte coating and the second solid electrolyte coating, has a layer thickness (d₁₂, d₁₃) within a range from ≧1 μm to ≦250 μm, for example from ≧5 μm to ≦100 μm.

In the context of a further embodiment, the solid electrolyte separator has a total layer thickness (d₁₀) within a range from ≧30 μm to ≦1000 μm, for example from ≧50 μm to ≦500 μm.

The solid electrolyte base layer may comprise one or more compositions or one or more layers.

The first solid electrolyte coating and the second solid electrolyte coating may have identical or different compositions.

For example, the solid electrolyte base layer and/or the at least one solid electrolyte coating, especially the first solid electrolyte coating and/or the second solid electrolyte coating, may comprise a mixture of one or more solid-state materials, for example one or more glass ceramic materials, and/or one or more polymers and/or one or more lithium ion-conducting inorganic fillers and/or one or more non-lithium ion-conducting inorganic fillers.

More particularly, the solid electrolyte base layer and/or the at least one solid electrolyte coating, for example the first solid electrolyte coating and/or the second solid electrolyte coating, may (each) comprise at least one solid-state lithium ion conductor, especially at least one inorganic solid-state lithium ion conductor.

For example, the solid electrolyte base layer and/or the at least one solid electrolyte coating, for example the first solid electrolyte coating and/or the second solid electrolyte coating, may (each) be formed from at least one solid-state lithium ion conductor, especially at least one inorganic solid-state lithium ion conductor. At the same time, the solid electrolyte base layer may especially be a solid-state electrolyte base layer and/or the at least one solid electrolyte coating may especially be a solid-state electrolyte coating. The solid electrolyte separator may especially be a solid-state electrolyte separator.

In the context of a further embodiment, the at least one solid electrolyte coating, especially the first solid electrolyte coating and/or the second solid electrolyte coating, comprises at least one solid-state lithium ion conductor, especially at least one inorganic solid-state lithium ion conductor, having a garnet-like crystal structure. For example, the at least one solid electrolyte coating, especially the first solid electrolyte coating and/or the second solid electrolyte coating, may be formed from at least one solid-state lithium ion conductor, especially at least one inorganic solid-state lithium ion conductor, having a garnet-like crystal structure. For example, the first solid electrolyte coating and the second solid electrolyte coating may comprise or be formed from at least one solid-state lithium ion conductor, especially at least one inorganic solid-state lithium ion conductor, having a garnet-like crystal structure.

A solid-state lithium ion conductor having a garnet-like crystal structure may especially be understood to mean a solid-state lithium ion conductor having a crystal structure that can be derived from the general garnet formula. The general garnet formula may, for example, be X₃Y₂[ZO₄]₃ where X, Y and Z represent different positions in the crystal lattice and may be occupied by one or more different ions or elements. For example, X may represent the dodecahedral position, Y the octahedral position and Z the tetrahedral position.

Solid-state lithium ion conductors having garnet-like crystal structure may advantageously be stable to air (and/or elemental oxygen) and moisture (and/or water) and metallic lithium. In addition, solid-state lithium ion conductors having garnet-like crystal structure may also be stable to elemental sulfur and/or sulfur compounds, such as polysulfides, disulfides and/or monosulfides. The lithium ion conductivity, especially at room temperature, of solid-state lithium ion conductors having garnet-like crystal structure may, if appropriate, however, be only within a range from about 10⁻⁷ S/cm to 10⁻⁴ S/cm.

In the context of one configuration of this embodiment, the at least one solid electrolyte coating, especially the first solid electrolyte coating and/or the second solid electrolyte coating, comprises at least one solid-state lithium ion conductor having the general chemical formula: LiₓA_{y}B_{z}O₁₂. In this formula, A may especially be a trivalent cation and/or divalent cation and/or monovalent cation, for example lanthanum and/or calcium and/or strontium and/or barium and/or magnesium and/or zinc and/or sodium and/or potassium. B may especially be a pentavalent cation and/or tetravalent cation and/or trivalent cation, for example niobium and/or tantalum and/or zirconium and/or hafnium and/or tin. x, y and z may especially be indices, for example 5 ≦x ≦10, for example 5 ≦x ≦7, 0 ≦y ≦3 and 0 ≦z ≦3. For example, the at least one solid electrolyte coating, especially the first solid electrolyte coating and/or the second solid electrolyte coating, may be formed from at least one solid-state lithium ion conductor having the general chemical formula: LiₓA_{y}B_{z}O₁₂. For example, the first solid electrolyte coating and the second solid electrolyte coating may comprise or be formed from at least one solid-state lithium ion conductor having the general chemical formula: LiₓA_{y}B_{z}O₁₂.

Solid-state lithium ion conductors having garnet-like crystal structure are described, inter alia, for example, in the publication DE 10 2007 030 604 A1.

In the context of a further embodiment, the solid electrolyte base layer comprises at least one solid-state lithium ion conductor, for example at least one vitreous and/or ceramic, sulfidic, for example sulfide-based, and/or phosphorus-containing and/or phosphate-containing solid-state lithium ion conductor. For example, the solid electrolyte base layer may be formed from at least one solid-state lithium ion conductor, for example at least one vitreous and/or ceramic, sulfidic, for example sulfide-based, and/or phosphorus-containing and/or phosphate-containing solid-state lithium ion conductor.

For example, the solid electrolyte base layer may comprise or be formed from at least one lithium sulfide, for example lithium phosphorus sulfide, for example lithium germanium phosphorus sulfide, for example Li₁₀GeP₂S ₁₂ and/or Li₄GeS₄ and/or Li_{3.25}Ge_{0.25}P_{0.75}S₄, and/or lithium tin phosphorus sulfide, for example Li₁₀SnP₂S₁₂, and/or lithium phosphorus sulfide, for example Li₇P₃S₁₁ and/or Li₂S—P₂S₅, and/or lithium phosphate, for example lithium aluminum germanium phosphate, for example Li_{1.4}Al_{0.4}Ge_{1.6}(PO₄)₃, and/or lithium aluminum titanium phosphate (LATP) and/or lithium silicon phosphate, for example Li_{3.6}Si_{0.6}P_{0.4}O₄, and/or lithium sulfide phosphate, for example lithium silicon sulfide phosphate, for example Li₂S—SiS₂—Li₃PO₄.

For example, the solid electrolyte base layer may comprise or be formed from at least one solid-state lithium ion conductor, for example at least one vitreous and/or ceramic, germanium-containing, for example sulfidic, for example sulfide-based, and/or phosphorus-containing and/or phosphate-containing solid-state lithium ion conductor, for example lithium aluminum germanium phosphate, for example Li_{1.4}Al_{0.4}Ge_{1.6}(PO₄)₃, and/or lithium germanium phosphorus sulfide, for example Li₁₀GeP₂S₁₂, and/or another sulfidic, for example sulfide-based, solid-state lithium ion conductor. Germanium-containing, for example sulfidic and/or phosphorus-containing and/or phosphate-containing, solid-state lithium ion conductors, such as lithium aluminum germanium phosphate and/or lithium germanium phosphorus sulfide, and/or optionally other sulfidic solid-state lithium ion conductors may advantageously have a very high lithium ion conductivity, for example within a range from about 10⁻³ S/cm to 10⁻¹ S/cm. Such solid-state lithium ion conductors can, however, be unstable to metallic lithium and generally also to air (or elemental oxygen) and moisture (or water).

More particularly, the solid electrolyte base layer may comprise at least one solid-state lithium ion conductor, for example at least one vitreous and/or ceramic, germanium-containing, for example sulfidic, for example sulfide-based, and/or phosphorus-containing and/or phosphate-containing solid-state lithium ion conductor. For example, the solid electrolyte base layer may be formed from at least one solid-state lithium ion conductor, for example at least one vitreous and/or ceramic, germanium-containing, for example sulfidic, for example sulfide-based, and/or phosphorus-containing and/or phosphate-containing solid-state lithium ion conductor.

In the context of one configuration, the solid electrolyte base layer comprises at least one solid-state lithium ion conductor, for example at least one vitreous and/or ceramic, germanium-containing, sulfidic, for example sulfide-based, solid-state lithium ion conductor. For example, the solid electrolyte base layer may be formed from at least one solid-state lithium ion conductor, for example at least one vitreous and/or ceramic, germanium-containing, sulfidic, for example sulfide-based, solid-state lithium ion conductor.

In the context of a further configuration, the solid electrolyte base layer comprises at least one solid-state lithium ion conductor, for example at least one vitreous and/or ceramic, germanium-containing, phosphorus-containing and/or phosphate-containing solid-state lithium ion conductor. For example, the solid electrolyte base layer may be formed from at least one solid-state lithium ion conductor, for example at least one vitreous and/or ceramic, germanium-containing, phosphorus-containing and/or phosphate-containing solid-state lithium ion conductor.

In the context of a specific configuration, the solid electrolyte base layer comprises lithium aluminum germanium phosphate, for example Li_{1.4}Al_{0.4}Ge_{1.6}(PO₄)₃, and/or lithium germanium phosphorus sulfide, for example Li₁₀GeP₂S₁₂. For example, the solid electrolyte base layer may be formed from lithium aluminum germanium phosphate, for example Li_{1.4}Al_{0.4}Ge_{1.6}(PO₄)₃, and/or lithium germanium phosphorus sulfide, for example Li₁₀GeP₂S₁₂.

The solid electrolyte base layer and/or the at least one solid electrolyte coating, especially the first solid electrolyte coating and/or the second solid electrolyte coating, and/or the solid electrolyte separator may especially have a gas-tight configuration. In this way, it is advantageously possible to prevent oxygen (O₂), moisture (H₂O) and/or other unwanted gases, such as carbon dioxide (CO₂), from passing from the cathode to the anode.

With regard to further technical features and advantages of the solid electrolyte separator of the invention, reference is hereby made explicitly to the elucidations in connection with the cell of the invention and the battery of the invention, and to the figures and the description of the figures.

The invention further provides a lithium cell comprising a cathode, an anode and a solid electrolyte separator of the invention.

The anode may especially comprise lithium. For example, the anode may comprise or be formed from metallic lithium and/or a lithium alloy and/or a lithium insertion material and/or a lithium intercalation material and/or a lithium conversion material. For example, the anode may comprise metallic lithium and/or an alloy, for example a lithium-silicon alloy and/or a tin-based alloy.

The cell may especially be a lithium conversion cell, for example a lithium-oxygen cell, for example a lithium-air cell, or a lithium-sulfur cell.

More particularly, the solid electrolyte separator may be arranged between the anode and the cathode.

In the context of one embodiment, the cathode comprises at least one catalyst for catalysis of a reduction of elemental oxygen to oxygen ions and/or for catalysis of an oxidation of oxygen ions to elemental oxygen. This cell may especially be a lithium-oxygen cell, for example a lithium-air cell.

In the context of another embodiment, the cathode comprises elemental sulfur and/or at least one sulfur compound. This cell may especially be a lithium-sulfur cell.

In addition, the cathode may, for example—both in the case of a lithium-oxygen cell, for example a lithium-air cell, and in the case of a lithium-sulfur cell—comprise at least one electrical conduction medium, especially at least one conductive carbon, for example graphite and/or carbon black, and/or metal particles, and/or at least one binder.

In addition, the cell may comprise a cathode current collector and/or an anode current collector. For example, the cathode current collector may be coated with the cathode. The anode current collector may, for example, be coated with the anode.

The cell may further comprise at least one lithium ion-conducting liquid electrolyte.

Advantageously, in the case of use of a solid electrolyte separator of the invention, the use of an additional polymer separator is unnecessary. The cell can therefore be free of an additional polymer separator. In this way, it is advantageously possible to achieve a reduced internal resistance of the cell or battery.

If appropriate, the cell may, however, nevertheless additionally comprise at least one polymer separator, for example a polymer separator on the anode side and/or a polymer separator on the cathode side.

In the context of a further embodiment, the cell is a lithium-oxygen cell. For example, this cell may be a lithium-air cell.

In the case of a lithium-oxygen cell, for example a lithium-air cell, the cathode current collector may especially be porous. For example, this cathode current collector may be a metal mesh, for example a nickel mesh, or be formed from expanded metal or be a carbon nonwoven. In this way, it is advantageously possible to achieve an increased reaction surface area and/or an oxygen flow to parts, for example all parts, of the cathode.

In addition, the cell, in the case of a lithium-oxygen cell, may comprise, for example, a gas distributor (flow field), especially for supply and/or removal of oxygen. The gas distributor may especially be provided on the cathode. If appropriate, the gas distributor may be designed for supply and/or removal of oxygen to and from a plurality of cathodes, for example from a plurality of cells. In this way, it is advantageously possible to assure a homogeneous distribution of oxygen to the cathode(s).

With regard to further technical features and advantages of the cell of the invention, reference is hereby made explicitly to the elucidations in connection with the solid electrolyte separator of the invention and the battery of the invention, and to the figures and the description of the figures.

The invention further provides a lithium battery comprising lithium cells of the invention.

More particularly, the lithium battery may be a lithium conversion battery, for example a lithium-oxygen battery, for example a lithium-air battery, or a lithium-sulfur battery. More particularly, the lithium battery may be a lithium-oxygen battery, for example a lithium-air battery.

A lithium conversion battery may especially be understood to mean a system comprising a plurality of lithium conversion cells.

A lithium-oxygen battery may especially be understood to mean a system comprising a plurality of lithium-oxygen cells. For example, a lithium-oxygen battery may be a lithium-air battery, especially one comprising a plurality of lithium-air cells.

A lithium-sulfur battery may especially be understood to mean a system comprising a plurality of lithium-sulfur cells.

More particularly, the lithium battery may comprise at least two lithium cells. For example, the lithium battery may comprise a multitude of lithium cells. For example, the lithium battery may comprise at least one battery module composed of connected lithium cells. These lithium cells may be connected, for example, in parallel and/or in series. For example, the lithium battery may be what is called a battery pack comprising at least one battery module. For example, the battery pack may comprise a plurality of connected battery modules.

The lithium battery may be integrated, for example, into a stationary system, for example into a power storage system and/or into a wind power plant, for example into a wind turbine, and/or into a photovoltaic system, and/or into a mobile system, for example into a vehicle such as a hybrid vehicle and/or electrical vehicle, and/or into a consumer application, for example into a laptop and/or mobile phone. Therefore, the invention also relates to a stationary system, for example a power storage system and/or a wind power plant, for example a wind turbine, and/or a photovoltaic system, and/or a mobile system, for example a vehicle such as a hybrid vehicle and/or electrical vehicle, and/or an electronic device, for example a consumer application, for example a laptop and/or a mobile phone, comprising a lithium cell and/or lithium battery of the invention.

With regard to further technical features and advantages of the battery of the invention, reference is hereby made explicitly to the elucidations in connection with the solid electrolyte separator of the invention and the cell of the invention, and to the figures and the description of the figures.

### BRIEF DESCRIPTION OF THE DRAWINGS

Further advantages and advantageous configurations of the subjects of the invention are illustrated by the drawings and elucidated in the description which follows. It should be noted here that the drawings are merely of descriptive character and are not intended to restrict the invention in any way at all. The figures show:

FIG. 1 a schematic cross section through one embodiment of a solid electrolyte separator of the invention for a lithium cell having a solid electrolyte base layer coated on both sides with a solid electrolyte coating; and

FIG. 2 a schematic cross section through one embodiment of a cell of the invention having a solid electrolyte separator shown in FIG. 1.

### DETAILED DESCRIPTION

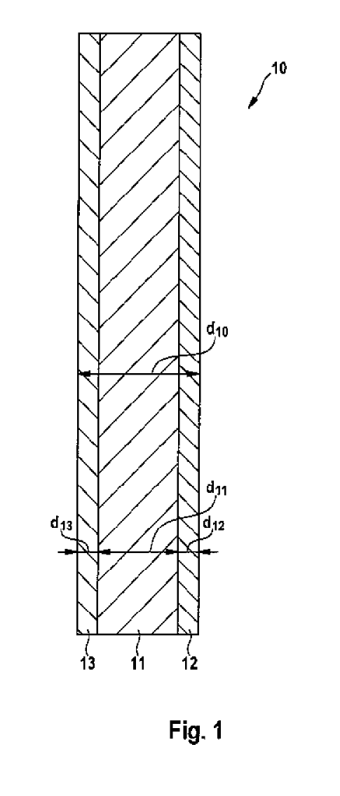

FIG. 1 shows that the solid electrolyte separator 10 comprises a solid electrolyte base layer 11 coated firstly with a first solid electrolyte coating 12 and secondly with a second solid electrolyte coating 13. In this case, the solid electrolyte base layer 11 may especially have a higher lithium ion conductivity than the first solid electrolyte coating 12 and than the second solid electrolyte coating 13.

FIG. 1 illustrates that the first solid electrolyte coating 12 and the second solid electrolyte coating 13 have layer thicknesses d₁₂, d₁₃ lower than layer thickness d₁₁ of the solid electrolyte base layer 11. By virtue of the lower layer thicknesses d₁₂, d₁₃ of the solid electrolyte coatings 12, 13, it is advantageously possible to compensate for a lower lithium ion conductivity of the solid electrolyte coatings 12, 13. In this case, the solid electrolyte separator 10 may have, for example, a total layer thickness d₁₀ within a range from ≧30 μm to ≦1000 μm, for example from ≧50 μm to ≦500 μm.

The first solid electrolyte coating 12 and the second solid electrolyte coating 13 may especially be formed from a material stable to air, moisture and metallic lithium. More particularly, the first solid electrolyte coating 12 and the second solid electrolyte coating 13 may comprise at least one solid-state lithium ion conductor having a garnet-like crystal structure. Solid-state lithium ion conductors having a garnet-like crystal structure may advantageously be stable to air, moisture and metallic lithium. By virtue of the solid electrolyte base layer 11 being coated on both sides with the solid electrolyte coatings 12, 13 and the solid electrolyte coatings 12, 13 being stable to air, moisture and metallic lithium, it is advantageously possible to form the solid electrolyte base layer 11 from a material which is itself unstable to air, moisture and metallic lithium but can have a particularly high lithium ion conductivity. For example, the solid electrolyte base layer 11 may comprise or be formed from at least one solid-state lithium ion conductor, especially at least one germanium-containing, sulfidic and/or phosphorus-containing and/or phosphate-containing solid-state lithium ion conductor, for example lithium germanium phosphorus sulfide and/or lithium aluminum germanium phosphate.

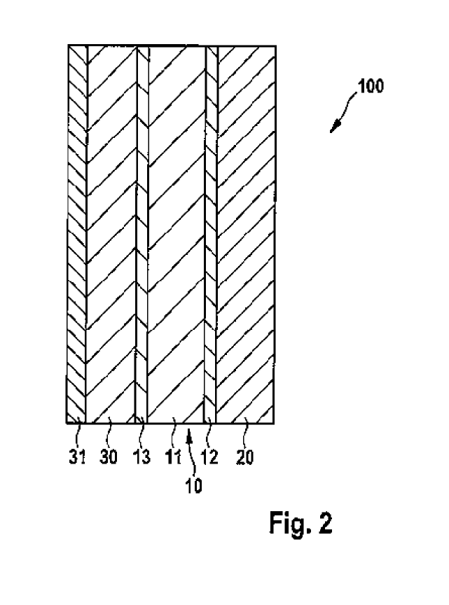

FIG. 2 shows one embodiment of a lithium cell 100, for example a lithium conversion cell, for example a lithium-oxygen cell or lithium-sulfur cell, and illustrates that the cell 100 comprises a cathode 20 and an anode 30, between which is arranged the solid electrolyte separator 10 shown in FIG. 1.

FIG. 2 illustrates that the anode 30 is equipped here with an anode current collector 31. The anode 30 may, for example, comprise metallic lithium. In this case, for example, the anode current collector 31 may be coated with metallic lithium or another anode material, for example an alloy 30.

1. A solid electrolyte separator (10) for a lithium cell (100), comprising a solid electrolyte base layer (11),
wherein the solid electrolyte base layer (11) has been coated firstly with a first solid electrolyte coating (12) and secondly with a second solid electrolyte coating (13).

2. The solid electrolyte separator (10) according to claim 1, wherein the solid electrolyte base layer (11) has a higher lithium ion conductivity than the first solid electrolyte coating (12) and than the second solid electrolyte coating (13).

3. The solid electrolyte separator (10) according to claim 1, wherein the first solid electrolyte coating (12) and the second solid electrolyte coating (13) have a lower layer thickness (d₁₂, d₁₃) than the solid electrolyte base layer (11).

4. The solid electrolyte separator (10) according to claim 1, wherein the first solid electrolyte coating (12) and/or the second solid electrolyte coating (13) is formed from a material which is stable to air, moisture and metallic lithium.

5. The solid electrolyte separator according to claim 1,
wherein the solid electrolyte base layer (11) has a layer thickness (d₁₁) within a range from ≧25 μm to ≦500 μm, especially from ≧50 μm to ≦300 μm.

6. The solid electrolyte separator (10) according to claim 1, wherein the first solid electrolyte coating (12) and/or the second solid electrolyte coating (13) comprises at least one solid-state lithium ion conductor having a garnet-like crystal structure.

7. The solid electrolyte separator (10) according to claim 1, wherein the first solid electrolyte coating (12) and/or the second solid electrolyte coating (13) comprises at least one solid-state lithium ion conductor having the general chemical formula
LiₓA_{y}B_{z}O₁₂
where A is a trivalent cation and/or divalent cation and/or monovalent cation,
where B is a pentavalent cation and/or tetravalent cation and/or trivalent cation, and
where 5 ≦x ≦10, 0 ≦y ≦3 and 0 ≦z ≦3.

8. The solid electrolyte separator (10) according to claim 1, wherein the solid electrolyte base layer (11) comprises at least one sulfidic and/or phosphorus-containing and/or phosphate-containing solid-state lithium ion conductor.

9. The solid electrolyte separator (10) according to claim 1, wherein the solid electrolyte base layer (11) comprises at least one germanium-containing solid-state lithium ion conductor.

10. The solid electrolyte separator (10) according to claim 1, wherein the solid electrolyte base layer (11) comprises lithium germanium phosphorus sulfide and/or lithium aluminum germanium phosphate.

11. A lithium cell (100), comprising a cathode (20), an anode (30) and a solid electrolyte separator (10) according to claim 1.

12. A cell (100) according to claim 11, wherein the cathode (20) comprises at least one catalyst for catalysis of a reduction of elemental oxygen to oxygen ions and/or for catalysis of an oxidation of oxygen ions to elemental oxygen or elemental sulfur and/or at least one sulfur compound.

13. The cell (100) according to claim 10, wherein the cathode (20) further comprises at least one conduction medium, and at least one binder.

14. The cell (100) according to claim 11, wherein the cell (100) is a lithium-oxygen cell or a lithium-sulfur cell.

15. A lithium battery, comprising lithium cells (100) according to claim 11

16. The solid electrolyte separator according to claim 1,
wherein the solid electrolyte base layer (11) has a layer thickness (d₁₁) within a range from ≧50 μm to ≦300 μm.

17. The solid electrolyte separator according to claim 1,
wherein the first solid electrolyte coating (12) and/or the second solid electrolyte coating (13) have a layer thickness (d₁₂, d₁₃) within a range from ≧1 μm to ≦250 μm.

18. The solid electrolyte separator according to claim 1,
wherein the first solid electrolyte coating (12) and/or the second solid electrolyte coating (13) have a layer thickness (d₁₂, d₁₃) within a range from ≧5 μm to ≦100 μm.

19. The solid electrolyte separator according to claim 1,
wherein the solid electrolyte separator (10) has a total layer thickness (d₁₀) within a range from ≧30 μm to ≦1000 μm.

20. The solid electrolyte separator according to claim 1,
wherein the solid electrolyte separator (10) has a total layer thickness (d₁₀) within a range from ≧50 μm to ≦500 μm.

21. The solid electrolyte separator according to claim 1,
wherein the solid electrolyte base layer (11) has a layer thickness (dᵢᵢ) within a range from ≧25 μm to ≦500 μm,
wherein the first solid electrolyte coating (12) and/or the second solid electrolyte coating (13) have a layer thickness (d₁₂, d₁₃) within a range from ≧1 μm to ≦250 μm, and
wherein the solid electrolyte separator (10) has a total layer thickness (d₁₀) within a range from ≧30 μm to ≦1000 μm.

22. The solid electrolyte separator (10) according to claim 7, wherein the trivalent cation and/or divalent cation and/or monovalent cation of A includes lanthanum and/or calcium and/or strontium and/or barium and/or magnesium and/or zinc and/or sodium and/or potassium, and wherein the pentavalent cation and/or tetravalent cation and/or trivalent cation of B includes niobium and/or tantalum and/or zirconium and/or hafnium and/or tin.

23. The solid electrolyte separator (10) according to claim 1, wherein the solid electrolyte base layer (11) comprises at least one sulfidic and/or phosphorus-containing and/or phosphate-containing solid-state lithium ion conductor.

24. The cell (100) according to claim 10, wherein the cathode (20) further comprises at least one conductive carbon and/or metal particles, and at least one binder.

25. The cell (100) according to claim 11, wherein the cell (100) is a lithium-oxygen cell.
